(19) United States
(12) Patent Application Publication
(10) Pub. No.: US 2016/0264444 A1
(43) Pub. Date: Sep. 15, 2016

(54) THERMAL TREATMENT SYSTEM AND METHOD FOR EFFICIENT PROCESSING OF ORGANIC MATERIAL

(71) Applicant: SGC ADVISORS, LLC, Atlanta, GA (US)

(72) Inventor: Joseph E. Zuback, Camarillo, CA (US)

(21) Appl. No.: 15/034,300

(22) PCT Filed: Nov. 4, 2014
(86) PCT No.: PCT/US14/63811

§ 371 Date: May 4, 2016

Related U.S. Application Data
(60) Provisional application No. 61/899,495, filed on Nov. 4, 2013.

(51) Int. Cl. C02F 9/00; C02F 11/10; C02F 11/12; C02F 11/18; C02F 11/04

(52) U.S. Cl. CPC C02F 9/00; C02F 11/18; C02F 11/04; C02F 11/121; C02F 11/127; C02F 11/10; C02F 2301/046; C02F 2301/066

(57) ABSTRACT

A thermal treatment system and method is disclosed for processing organic material. In a first embodiment, the system includes a thermal input device and a reaction device to thermally treat organic material to achieve cell lysing and cell formation, a separation device to separate inert solids from the organic material to produce a liquid stream with low concentrations of suspended solids, and a “high rate” biological treatment device to produce methane from the liquid stream. In a second embodiment, the system includes a pre-thickening device to minimize feed volume by pre-thickening prior to thermal treatment a thermal input device, a reaction device, and a solids separation device to selectively remove dense, inert particles from the thermally treated organic material prior to anaerobic biological treatment, with waste biosolids from anaerobic treatment being recycled to the pre-thickening device.

### CROSS REFERENCE TO RELATED APPLICATION

This application claims priority to U.S. Provisional Patent Application Ser. No. 61/899,495, filed Nov. 4, 2013, the disclosure of which is hereby expressly incorporated by reference herein in its entirety.

### FIELD OF THE DISCLOSURE

The present disclosure relates to processing of organic material. More particularly, the present disclosure relates to a thermal treatment system and method for processing organic material.

### BACKGROUND OF THE DISCLOSURE

Organic material, such as sludge from sewage and wastewater treatment plants (WWTP), represents a serious disposal problem. This sludge generally contains a mixture of solids, commonly referred to as biosolids, and varying amounts of free water.

The large volume of cell-bound water in biosolids makes the disposal of sewage sludge containing biosolids challenging. In particular, the cost of incinerating sewage sludge is prohibitive because the cell-bound water gives biosolids a net negative lower heating value. Similarly, if sewage sludge is thermally dewatered, the process may have a net negative energy balance due to the energy required to evaporate water from the sewage sludge. Also, the cost of transporting sewage sludge is significant because the cell-bound water impacts the weight of the sludge. Usually the WWTP must pay a “tipping fee” to have another party dispose of its biosolids. Sludge containing biosolids is presently landfilled, land-applied, or dried and used as a fertilizer. However, these disposal methods may have negative environmental effects, such as the generation of undesirable odors and the contamination of soil or groundwater by living disease-causing organisms, toxic heavy metals, and/or other chemical or pharmaceutical compounds contained in the biosolids. Between approximately 7.1 and 7.6 million dry (short) tons of biosolids are produced each year in the U.S. alone. Thus, an adequate disposal method is important.

In addition to the current need for an adequate method of disposing of biosolids, there is growing public support for increased utilization of renewable, or “green”, energy sources. Well-known forms of renewable energy include solar energy, wind energy, and geothermal energy, but these sources lack an adequate supply. Biomass materials, such as mill residues, agricultural crops and wastes, and industrial wastes, have long been used as renewable fuels. Biosolids, on the other hand, have not previously been considered as a renewable energy source due to the large volume of cell-bound water contained therein. As discussed above, the large volume of cell-bound water in biosolids significantly impacts both the cost of incinerating biosolids and the cost of transporting biosolids.

Accordingly, new systems and methods for processing and disposing of organic material are needed.

### SUMMARY

The present disclosure provides a thermal treatment system and method for processing organic material. In the primary mode of operation, the system treats undigested material to break down and dissolve organic material to facilitate biological digestion, separates undigestible solid materials from the organic material following thermal treatment, and converts digestible dissolved and undissolved organic materials to methane via anaerobic biological treatment.

According to an embodiment of the present disclosure, a thermal treatment system is provided for processing a slurry including organic material and water. The system includes: a pump that pressurizes the slurry to a pressure above the saturation pressure of water at a subsequent elevated temperature; at least one thermal input device that heats the slurry to the elevated temperature sufficient for cell lysing and char formation; a reaction device that provides a retention time at the elevated temperature to thermally treat the heated slurry at the elevated temperature; a solids separation device that separates the thermally treated slurry into at least a first stream comprising organic materials and a second stream comprising inert materials; and an anaerobic biological reactor that converts organic materials in the first stream to methane, the biological reactor retaining solids longer than liquids such that solids have a longer residence time in the biological reactor than liquids.

According to another embodiment of the present disclosure, a thermal treatment system is provided for processing a slurry including organic material and water. The system includes: a pump that pressurizes the slurry to a pressure above the saturation pressure of water at a subsequent elevated temperature; at least one thermal input device that heats the slurry to the elevated temperature sufficient for cell lysing and char formation; a reaction device that provides a retention time at the elevated temperature to thermally treat the heated slurry at the elevated temperature; a solids separation device that separates the thermally treated slurry into at least a first stream comprising organic materials and a second stream comprising inert materials; and an anaerobic biological reactor that converts organic materials in the first stream to methane, the biological reactor recycling waste biosolids to the pump, the at least one thermal input device, and the reaction device for further thermal treatment.

According to yet another embodiment of the present disclosure, a method is provided for processing a slurry including an organic material and water. The method includes the steps of: thermally treating the slurry by heating and pressurizing the slurry; separating the treated slurry into at least a first liquid stream and a second solid material suitable for disposal as an inert waste; biologically treating the first liquid stream to produce methane and waste biosolids; and recycling the waste biosolids from the biological treatment step to the thermal treatment step.

According to still yet another embodiment of the present disclosure, a thermal treatment system is provided for processing an organic material. The system includes a thermal input device that heats the organic material and dissolves organic material to enhance digestion, a dewatering process to separate undissolved materials from the thermally treated organic material to produce a filtrate that contains concentrations of suspended solids less than 10,000 mg/L, and a “high rate” anaerobic biological treatment process to convert dissolved and suspended organic material in the filtrate to methane via anaerobic bacteria. A high rate anaerobic biological treatment process is any anaerobic treatment process that retains biomass and other suspended solids within the biological reactor such that the residence time of the solid material entering the reactor with the feed is greater than the hydraulic residence time of the liquid entering the reactor with the solid material. Examples of high rate anaerobic reactors include but are not limited to granular fluidized bed reactors, sludge blanket reactors, and anaerobic membrane bioreactors.

According to still yet another embodiment of the present disclosure, a thermal treatment system is provided for processing an organic material. The system includes a thickener to separate water from organic material received from a municipal wastewater treatment plant such as primary and secondary treatment waste sludge and to concentrate the organic material to a concentration desirable for thermal treatment, a thermal input device that heats the organic material and dissolves organic material to enhance digestion, a separation device that separates relatively dense solids such as grit, inorganic and organic precipitates, and other relatively dense inert materials from dissolved organic matter and relatively light undissolved organic matter based upon particle density or size differences, and an anaerobic biological treatment process. Waste solids from the anaerobic biological treatment process are directed back to said thickener for re-concentration and re-processing through the thermal input device, separation device based upon density differences, and anaerobic treatment process. Said separation device separates particles based upon particle density and size differences and includes but is not limited to settling tanks, hydrocyclones, other devices that rely upon different particle behavior in response to external forces such as gravity or centrifugal force, and filters that separate particles based upon differences in particle size. Said anaerobic treatment process includes but is not limited to anaerobic lagoons and ponds, complete mix anaerobic digesters, and high rate anaerobic treatment processes such as but not limited to granular fluidized bed reactors, sludge blanket reactors, and anaerobic membrane bioreactors.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a schematic diagram of a first system for treating organic waste; and

FIG. 2 is a schematic diagram of a second system for treating organic waste.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

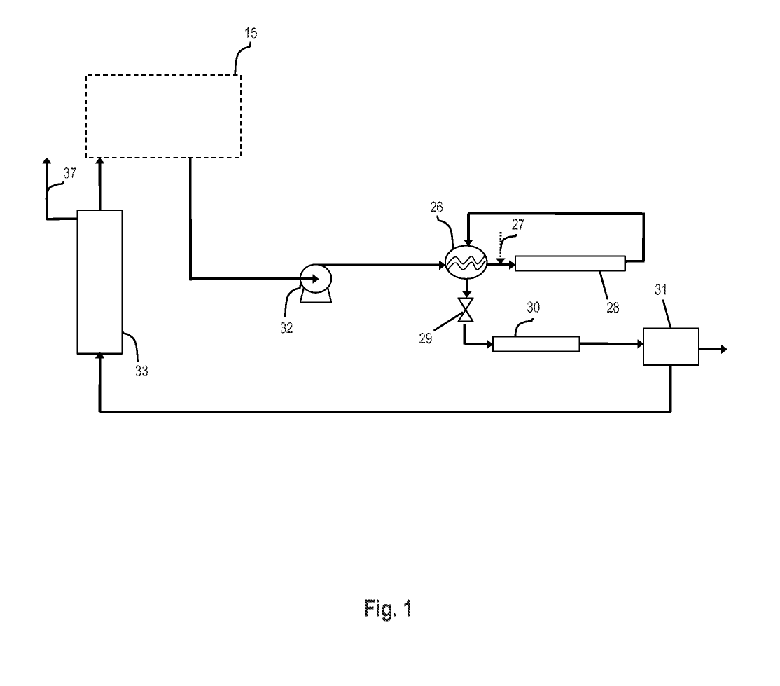

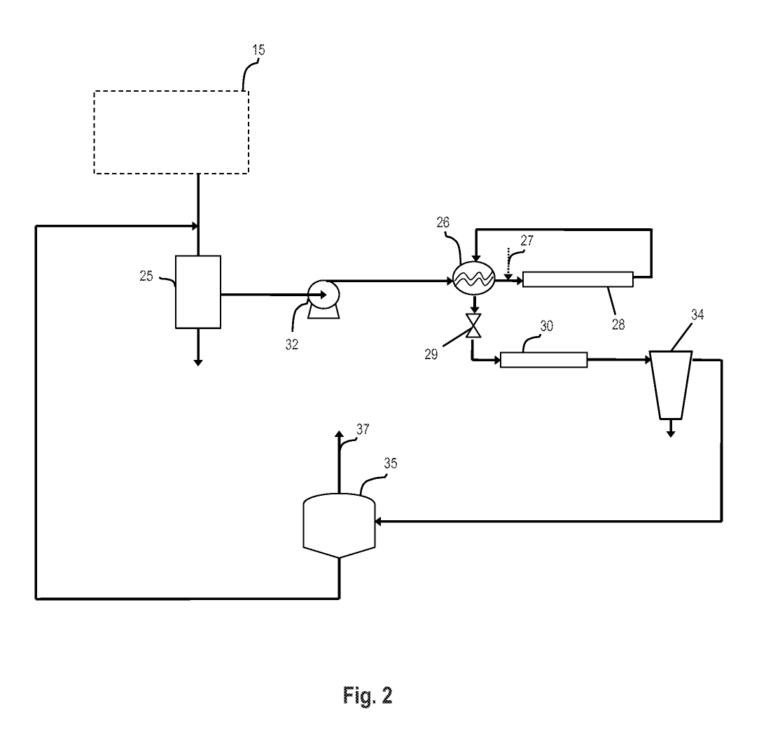

A thermal treatment system is disclosed for processing an organic feedstock received from a sludge generation process, such as a wastewater biological treatment plant (WWTP) 15. In the illustrated embodiments of FIG. 1 and FIG. 2, the system further treats the organic feedstock to generate a semi-solid material suitable for disposal or use as a fertilizer and/or a renewable gas fuel product. The various modes of operation are described further below.

The first mode of operation will be described with reference to FIG. 1. The system receives the organic feedstock from WWTP 15. The incoming organic feedstock from WWTP 15 may include sewage in the form of a sludge, which generally contains a mixture of solids, commonly referred to as biosolids, and varying amounts of water. According to an exemplary embodiment of the present disclosure, the sewage is raw or untreated sewage sludge. It is also within the scope of the present disclosure that the sewage may be pre-treated or processed sewage sludge, such as sludge containing Class A or Class B biosolids. The incoming organic feedstock from WWTP 15 may include either uncombined individual sludge or a combination of settled sewage from primary treatment called primary sludge and settled biological floc from secondary treatment called waste activated sludge, either in the form of a slurry or a dewatered semi-solid sludge cake. The term “biosolids” as used throughout this disclosure has its ordinary meaning in the art. The moisture content of the incoming organic feedstock from WWTP 15 may be as low as approximately 65 vol. %, 70 vol. %, 75 vol. %, or 80 vol. % and as high as approximately 85 vol. %, 90 vol. %, 95 vol. %, or 99 vol. %, or within any range defined between any pair of the foregoing values, for example. The remaining volume of the organic feedstock may comprise biosolids, such as dead organic cells, bacterial cell masses, inorganic compounds (e.g., grits, sand), and other solids, as well as dissolved substances, such as ammonia (NH₃). The solids content of the incoming organic feedstock from WWTP 15 may be as low as approximately 1 vol. %, 5 vol. %, 10 vol. %, or 15 vol. % and as high as approximately 20 vol. %, 25 vol. %, 30 vol. %, or 35 vol. %, or within any range defined between any pair of the foregoing values, for example.

In addition to wastewater treatment plant sludge, the organic feedstock from WWTP 15 may include other organic materials, especially those containing cell-bound water. For example, the organic feedstock may include paper mill sludge, food waste, plant matter (e.g., rice hulls, hay straw), discarded cellulosic packaging material, bagasse, green waste (e.g., leaves, clippings, grass), algae, wood and wood waste, clinker or other residue from combustion of wood, palm oil residue, and short rotation crops. The organic feedstock may also include animal carcasses. The organic feedstock may also include agricultural waste such as sewage material obtained from the live-stock industry (e.g., hog manure, chicken litter, cow manure). The organic feedstock may also include crops grown specifically for use in the process, such as switch grass or other plants. The organic feedstock may also include municipal solid waste, fats, oils, and greases (FOG), medical waste, paper waste, refuse derived fuels, Kraft Mill black liquor, or hydrophilic non-renewable fuels (e.g., low-rank coals). In an exemplary embodiment, the organic feedstock may include a blend of biosolids and other organic materials, including biomass, to enhance the heating value of the final product and/or increase the scale of production.

To prepare the organic feedstock for subsequent heating, pump 32 pressurizes the organic feedstock to a pressure above the saturation pressure of water at a subsequent elevated temperature. Pressurizing the organic feedstock maintains a liquid phase in the slurry during subsequent heating by maintaining water in the slurry below the saturated steam curve during the subsequent heating steps and substantially inhibiting water in the slurry from vaporizing. Depending on the subsequent elevated temperature, pump 32 may pressurize the organic feedstock to a pressure as low as approximately 10 psig, 30 psig, or 50 psig and as high as approximately 1000 psig, 1300 psig, 1500 psig, or more, or within any range defined between any pair of the foregoing values, for example.

The pressure supplied by pump 32 may vary depending on the viscosity of the organic feedstock. As the viscosity of the organic feedstock increases, the pressure supplied by pump 32 may be increased to account for downstream pressure loss. Care must be exercised to provide pump 32 with an adequate net pump suction head (NPSH), either hydraulically or by mechanical assistance, considering that the organic feedstock may be very viscous and may carry dissolved gases. In one embodiment, the pressurized organic feedstock may travel from pump 32 along a vertical or downward-sloping plane to, with assistance from the Earth's gravitational force, reduce the demand on pump 32 and/or reduce the likelihood of gritty or sticky solid portions of the organic feedstock collecting downstream.

Next, the pressurized slurry from pump 32 continues to one or more thermal input devices to subject the slurry to a thermal hydrolysis process by heating the organic material to an elevated temperature under the elevated pressure. In the illustrated embodiment of FIG. 1, the pressurized slurry is heated by a first thermal input device, illustratively a heat exchanger 26, and a second thermal input device, illustratively a steam injection nozzle 27, arranged in series. Specifically, the pressurized slurry is first heated in the heat exchanger 26 via exchange of heat with pressurized slurry exiting a reactor 28, and subsequently via addition of steam at the steam injection nozzle 27 at a point in the system downstream of heat exchanger 26 and upstream of reactor 28. Other heating sources and heating arrangements can be utilized.

According to an exemplary embodiment of the present disclosure, the thermal input devices heat the pressurized slurry to a temperature sufficient to cause cellular lysing, decarboxylation, and/or carbonization. The elevated temperature may also be sufficiently high to convert dissolved and insoluble refractory organic material into biodegradable dissolved organic material. In certain embodiments, cellular lysing begins at a temperature of about 230° F. (110° C.). At this lysing temperature, cellular structures (e.g., cellular walls, cellular lipid-bilayer membranes, internal cellular membranes) in the slurry begin to rupture. As a result, the cells begin to break down into particles of smaller size and release their cell-bound water. Also, the viscosity of the heated slurry may decrease substantially. Additionally, impurities (e.g., sodium, potassium, chlorine, sulfur, nitrogen, toxic metals) may separate from the ruptured cells as ions and dissolve into the liquid phase, making the impurities accessible for subsequent removal and disposal. To achieve such results, heat exchanger 26 and/or steam injection device 27 may heat the pressurized slurry to a temperature as low as 230° F. (110° C.), 240° F. (116° C.), or 250° F. (121° C.) and as high as 260° F. (127° C.), 270° F. (132° C.), 280° F. (138° C.), or more, or within any range defined between any pair of the foregoing values, for example.

The pressurized and heated slurry is then directed to reactor 28, as shown in FIG. 1. Inside reactor 28, the heated slurry is allowed to dwell at the lysing temperature to encourage more cells to rupture, produce char, and release more cell-bound water. Depending on the desired degree of cellular lysing and char production, the residence time in reactor 28 may be as low as 1 minute, 3 minutes, or 5 minutes and as high as 7 minutes, 9 minutes, 11 minutes, or more, or within any range defined between any pair of the foregoing values, for example.

Reactor 28 receives the heated slurry continuously. Also, the heated slurry flows horizontally through reactor 28 with separate valve-controlled nozzle connections at various points along the length of the reactor to enhance the removal of sand, grit, and other materials from the slurry, which will collect in the bottom of reactor 28. Reactor 28 may accommodate addition of an alkali, a reducing gas, or another compound to facilitate downstream removal of undesirable constituents. For example, reactor 28 may accommodate the addition of carbon monoxide to facilitate downstream removal of precipitated NH₃.

If necessary to maintain the lysing temperature, reactor 28 may be insulated with a jacket that retains heat in the contents of reactor 28. It is within the scope of the present disclosure that the slurry will generate heat in reactor 28, thereby reducing or eliminating the need for additional heating of reactor 28.

The slurry that exits reactor 28, referred to herein as pre-treated slurry, contains a mixture of liquid and solid materials. The liquid phase of the pre-treated slurry includes the once-cell-bound water that was released during lysing and dissolved compounds, including dissolved carbon dioxide, dissolved NH₃, dissolved mercury, and dissolved sulfur compounds. Volatile materials, such as carbon dioxide, may be forced to remain in the liquid phase under the high pressure supplied by pump 32. However, some gases may form in the process. To prevent the evolved gases from accumulating in the piping and equipment, the evolved gases may be continuously removed from vents located throughout the system. For example, vents may be located in reactor 28, at high points in the system, and in confined areas, such as centrifugal pump casings, having localized pressure drops that allow dissolved gases to evolve from the liquid slurry. The solid phase of the pre-treated slurry includes primarily ruptured cellular structures and inorganic compounds (e.g., grit, sand). The solid content of the pre-treated slurry may be as low as approximately 1% wt. %, 10 wt. %, 20 wt. %, or 30 wt. %, and as high as approximately 40 wt. % or 50 wt. %, or 75 wt. %, or within any range defined between any pair of the foregoing values, for example. The solid content of the pre-treated slurry may decrease in reactor 28 due to the release of bound organics into the liquid and gaseous phases, as well as chemical reactions among the constituents.

The pre-treated slurry from reactor 28 continues to heat exchanger 26, as shown in FIG. 1, or to another suitable cooler. The pre-treated slurry is cooled by exchange with the cool, incoming organic feedstock. Although a single heat exchanger 26 is illustrated in FIG. 1, it is within the scope of the present disclosure to cool the pre-treated slurry in stages using more than one heat exchanger. The slurry may be sufficiently cooled in heat exchanger 26 before being depressurized by a downstream pressure reducing valve 29 so that the freed cell-bound water in the slurry remains in the liquid phase during the cooling and subsequent depressurizing steps. Stated differently, the freed cell-bound water in the slurry may stay below the saturated steam curve during the cooling and subsequent depressurizing steps. Staying below the saturated steam curve during the cooling and subsequent depressurizing steps may provide several benefits. First, staying below the saturated steam curve may avoid energy loss due to vaporization. Also, staying below the saturated steam curve may produce a clean vapor stream of carbon dioxide and other volatile gases during depressurization rather than a blended stream of water vapor, carbon dioxide, and other gases. Finally, staying below the saturated steam curve may keep the freed water in the liquid state to aid in pumping the slurry after depressurization.

From heat exchanger 26, the cooled treated slurry is directed to the pressure reducing valve 29, as shown in FIG. 1. Following pressure reducing valve 29, the pressure of the post-treated slurry may be reduced to atmospheric pressure, 5 psig, or 10 psig, for example. The pressure reduction liberates volatile materials once forced to remain in the liquid phase, such as carbon dioxide, hydrogen sulfide, and other non-condensable gases. The pressure reduction may also liberate some small amounts of water vapor. However, by cooling the post-treated slurry before depressurization, as discussed above, most of the water will remain in the liquid phase for removal during subsequent mechanical dewatering and thermal drying processes. Following pressure reducing valve 29, vents may also be used to release vent gases that evolved elsewhere in the system.

From pressure reducing valve 29, an auxiliary heating vessel 30 is shown in FIG. 1 for holding the treated sludge at an elevated temperature for additional time necessary to comply with pathogen inactivation regulations and separation of volatile materials from the cooled treated slurry. The simultaneous reduction in pressure and temperature of the cooled treated slurry described in the previous paragraph liberates volatile materials once forced to remain in the liquid phase, such as carbon dioxide, hydrogen sulfide, mercaptans, and other non-condensable gases, as well as water vapor. Liberating these volatile materials from the vessel 30 before a subsequent biological treatment process may avoid having to liberate and then separate these volatile materials from the other useful gasses generated during the subsequent biological treatment process. Because NH₃ exists in equilibrium with water in the slurry, NH₃ may also evaporate along with the water vapor. Evaporating NH₃ may make the final product more suitable for subsequent combustion and may allow the evaporated NH₃ to be recovered, such as with an ammonia scrubber, and sold. Vents are provided within auxiliary heating vessel 30 for removal of liberated volatile materials. The outputs from auxiliary heating vessel 30 include a liberated vapor stream and a solid-liquid slurry stream. The liberated vapor stream exiting auxiliary heating vessel 30 may be captured, purified, and sold, burned to destroy odors, burned for energy recovery, processed to destroy undesirable components, or otherwise processed.

The solid-liquid slurry stream may be directed to a mechanical solids separation or dewatering device, illustratively centrifuge 31. Other suitable dewatering devices include settling tanks, filters, belt presses, rotary presses, and piston-type presses, such as Bucher presses, for example. An exemplary dewatering device may have a dewatering performance of about 40%, 50%, or more. The slurry entering centrifuge 31 includes primarily liquid materials with dissolved organics, with insoluble solid materials making up as little as approximately 5 wt. %, 10 wt. %, 15 wt. %, or 20 wt. % of the slurry and as much as approximately 25 wt. %, 30 wt. %, 35 wt. %, or 40 wt. % of the slurry, or within any range defined between any pair of the foregoing values, for example. In centrifuge 31, the slurry is subjected to high speed rotation to separate the liquid materials and dissolved organics from the solid materials. Most of the liquid materials and dissolved organics will exit centrifuge 31 in the liquid centrate stream, and most of the solid materials will exit centrifuge 31 in the semi-solid cake.

A polyelectrolyte may be added to the slurry before centrifuge 31 to promote flocculation and separation of sludge solids in centrifuge 31. According to an exemplary embodiment of the present disclosure, the polyelectrolyte dosage per dry ton of solids in the slurry may be as low as about 5 pounds, 10 pounds, 15 pounds, 20 pounds, or 25 pounds, and as high as about 30 pounds, 35 pounds, 40 pounds, 45 pounds, or 50 pounds, or within any range defined between any pair of the foregoing values.

The filtered water stream from the dewatering device, commonly referred to as a centrate when a centrifuge 31 is used as the mechanical dewatering device, contains a mixture of dissolved organic carbon (DOC) and undissolved organic and inorganic solids, also known as total suspended solids (TSS). As used herein, the DOC is the organic matter that is able to pass through a filter that generally ranges in size between 0.7 and 0.22 um. The DOC concentration of the filtered water stream may be as low as about 0.1 wt. % (1,000 ppm), 0.2 wt. % (2,000 ppm), 0.3 wt. % (3,000 ppm), 0.5 wt. % (5,000 ppm), or 1 wt. % (10,000 ppm), and as high as about 3 wt. %, 5 wt. %, 10 wt. %, or 15 wt. %, or within any range defined between any pair of the foregoing values. The DOC concentration of the filtered water stream may vary depending on the type of organic feedstock. For example, for a municipal waste feedstock, the DOC concentration of the filtered water stream may be about 0.1 wt. % (1,000 ppm) to 0.3 wt. % (3,000 ppm), whereas for a food waste feedstock, the DOC concentration of the filtered water stream may be about 1 wt. % (10,000 ppm) or more. The TSS concentration of the filtered water stream may be as low as about 100 mg/L, 500 mg/L, 1,000 mg/L, 1,500 mg/L, or 2,000 mg/L and as high as about 2,500 mg/L, 3,000 mg/L, 5,000 mg/L, 7,500 mg/L, or 10,000 mg/L, or within any range defined between any pair of the foregoing values. For example, in certain exemplary embodiments, the TSS concentration of the filtered water stream may be about 5,000 mg/L or less (e.g., about 100 mg/L to 5,000 mg/L), more specifically about 3,000 mg/L or less, and more specifically about 2,000 or less.

The centrate from centrifuge 31 may continue to a biological treatment process in a biological reactor 33, specifically an anaerobic biological reactor 33, as shown in FIG. 1, to convert the dissolved organics into useful gasses such as methane. Such gasses are shown exiting the biological reactor 33 via an exhaust 37 in FIG. 1. The temperature inside the biological reactor 33 may be controlled at about 95 to 160° F. Also, the pH inside the biological reactor 33 may be controlled to avoid ammonia toxicity from an excessively high concentration of un-ionized ammonia. For example, the pH inside the biological reactor 33 may be controlled at about 4 to 8.

Exemplary bacteria for use in the biological reactor 33 include acetogenic and/or methanogenic bacteria, for example. In certain embodiments, the biological reactor 33 may comprise two reactors or a single reactor with two zones to accommodate both acetogenic and methanogenic bacteria in a two-step biological process. First, the acetogenic bacteria may be used to hydrolyze the complex organics into volatile fatty acids, such as acetic acid or propionic acid. Second, the methanogenic bacteria may be used to convert the volatile fatty acids into methane rich biogas.

In conventional biosolids digestion systems, the material that is fed to the biological reactor may have a high concentration of non-biodegradable or inert suspended solids. Such materials may accumulate in the retained mass of bacteria (biomass) within the biological reactor and thus dilute the concentration of active biomass within the biological reactor necessary to metabolize the dissolved organics. Therefore, the high concentration of inert suspended solids typically limits conventional biological reactor designs to large vessels known as “low rate” or “complete mix” digesters, in which solids and liquids flow together through the digester such that the residence time of solids in the digester is approximately equal to the residence time of liquids in the digester.

In the present disclosure, the concentration of inert suspended solids in the filtered water stream (e.g., centrate) is significantly reduced by the dewatering device (e.g., centrifuge 31). Because of the relatively low concentration of inert solids in the filtered water stream (e.g., centrate) of the present disclosure, the biological reactor 33 may be a “high rate” anaerobic digester that retains biomass and other suspended solids longer than liquids, such that the residence time of solids in the biological reactor 33 is significantly greater than the residence time of liquids in the biological reactor 33. For example, the residence time of solids in the biological reactor 33 may be about 2 to 10 days, whereas the residence time of liquids in the biological reactor 33 may be about 12 to 48 hours. Stated differently, the biological reactor 33 may retain solids within the biological reactor 33 at concentrations that exceed the solids concentration entering the biological reactor 33 with the filtered water stream. The biological reactor 33 may retain biomass and other suspended solids longer than liquids by attachment and agglomeration in fluidized granular biomass or by using a mixed liquor of suspended solids, typically called a sludge blanket, with a concentration that is higher than the equivalent concentration of incoming biomass.

Exemplary biological reactors 33 include fluidized granular media reactors, sludge blanket reactors, and anaerobic membrane bioreactors, for example. Such biological reactors 33 may require significantly lower retention time and less space with less waste solids generated than is typical for conventional “complete mix” anaerobic treatment processes commonly used in wastewater treatment plants to methanize wastewater treatment plant sludge. Therefore, such biological reactors 33 may increase the rate of biological conversion of organic material to methane. Such biological reactors 33 may operate most efficiently when the TSS concentration of the filtered water stream is about 5,000 mg/L or less, for example.

The second mode of operation will be described with reference to FIG. 2, which may be similar to FIG. 1, except as described below. After leaving WWTP 15 and before being pressurized by pump 32, the organic feedstock may be subjected to a thickening or dewatering process in a thickening or dewatering device 25, such as settling, flotation, centrifuging, belt pressing, rotary pressing, or piston-type pressing, such as Bucher pressing, for example. The dewatering device 25 may be outside of and separate from the other system components. Additionally, the organic feedstock may be subjected to a polymer treatment process, a chemical treatment process, such as being mixed with a chelating agent, or a biological treatment process, such as being mixed with bacteria and protozoans.

Downstream of the reactor 28, the solid-liquid slurry stream may be directed to a separation device. The separation device may operate by reducing the flow velocity to allow settling by gravity, filtering based upon particle size, or inducing centrifugal forces to separate particles based on the ratio of their centripetal force to fluid resistance, for example. The separation device may be designed to remove particles sized larger than about 20 microns, 50 microns, 100 microns, 150 microns, 200 microns, or 250 microns, for example. The separation device may also be designed to remove particles having a specific gravity greater than about 0.9, 1.0, 1.5, 2.0, 2.5, 3.0, 3.5, 4.0, 4.5, or 5.0, which would include sand having a specific gravity of about 2.65.

An exemplary separation device is a hydrocyclone 34, as shown in FIG. 2. The slurry entering hydrocyclone 34 includes primarily liquid materials with dissolved organics, with insoluble solid materials making up as little as approximately 5 wt. %, 10 wt. %, 15 wt. %, or 20 wt. % of the slurry and as much as approximately 25 wt. %, 30 wt. %, 35 wt. %, or 40 wt. % of the slurry, or within any range defined between any pair of the foregoing values, for example. In hydrocyclone 34, the slurry is subjected to a hydraulic vortex to separate heavier solid particles such as grit and inorganic precipitates from the liquid with dissolved organics and lighter organic particles. Most of the liquid materials will exit hydrocyclone 34 in the liquid stream, and most of the solid materials will exit hydrocyclone 34 as a semi-solid material that resembles wet sand or powder. Other exemplary separation devices include filters, screens, horizontal flow grit chambers, and vortex-type grit removal systems, for example.

The separated liquid stream that exits hydrocyclone 34 may continue to an anaerobic treatment process in a biological reactor 35, specifically an anaerobic biological reactor 35, as shown in FIG. 2. The biological reactor 35 may be designed with adequate hydraulic retention time necessary to achieve adequate anaerobic biological methanization in the biological reactor 35 of organic materials present in the separated liquid stream. As discussed above, most of the heavier solid particles and inorganic precipitates were removed from the separated liquid stream in the separation device, so the separated liquid stream may contain primarily dissolved organics and lighter organic particles. The concentration of dissolved organics and lighter organic particles may be may be as low as about 50 mg/L, 100 mg/L, 500 mg/L, 1,000 mg/L, 1,500 mg/L, or 2,000 mg/L and as high as about 2,500 mg/L, 3,000 mg/L, 5,000 mg/L, 7,500 mg/L, or 10,000 mg/L, or within any range defined between any pair of the foregoing values, for example.

According to an exemplary embodiment of the present disclosure, the biological reactor 35 is a “low rate” or “complete mix” anaerobic digester, as shown in FIG. 2. Waste biosolids from the biological reactor 35 may be continuously or semi-continuously discharged to a dewatering device 25 that thickens the waste biosolids from the biological reactor 35 either separately from or commingled with the organic feedstock from WWTP 15. After being thickened in dewatering device 25, the waste biosolids produced by the biological methanization process in the biological reactor 35 may be recycled to the thermal processing reactor 28. The elevated temperature in the reactor 28 may convert dissolved and insoluble refractory organic materials into biodegradable dissolved organic materials for subsequent digestion in the biological reactor 35. In this manner, when refractory organic compounds are produced in reactor 28, recovered in the separated liquid stream from the hydrocyclone 34, and removed as waste biomass from the biological reactor 35 after anaerobic biological methanization, the refractory organic compounds may be continuously and repeatedly recycled to the reactor 28 to gradually degrade the organic compounds into either carbon dioxide or a dissolved organic compounds that can be biologically assimilated for subsequent digestion in the biological reactor 35.

While this invention has been described as having exemplary designs, the present invention can be further modified within the spirit and scope of this disclosure. This application is therefore intended to cover any variations, uses, or adaptations of the invention using its general principles such as but not limited to as shown in FIG. 1 and FIG. 2.

What is claimed is:

1. A thermal treatment system for processing a slurry comprising organic material and water, the system comprising:
a pump that pressurizes the slurry to a pressure above the saturation pressure of water at a subsequent elevated temperature;
at least one thermal input device that heats the slurry to the elevated temperature sufficient for cell lysing and char formation;
a reaction device that provides a retention time at the elevated temperature to thermally treat the heated slurry at the elevated temperature;
a solids separation device that separates the thermally treated slurry into at least a first stream comprising organic materials and a second stream comprising inert materials; and
an anaerobic biological reactor that converts organic materials in the first stream to methane, the biological reactor retaining solids longer than liquids such that solids have a longer residence time in the biological reactor than liquids.

2. The system of claim 1, wherein a polyelectrolyte is added to the thermally treated slurry before the solids separation device at a dosage of about 5 to 50 pounds per dry ton of solids in the thermally treated slurry.

3. The system of claim 1, wherein the first stream from the solids separation device has a concentration of total suspended solids less than about 3,000 mg/L.

4. The system of claim 1, wherein the first stream from the solids separation device has a concentration of total suspended solids less than about 2,000 mg/L.

5. The system of claim 1, wherein a temperature inside the biological reactor is about 95 to 160° F.

6. The system of claim 1, wherein a pH inside the biological reactor is about 4 to 8.

7. The system of claim 1, wherein the residence time of solids in the biological reactor is about 2 to 10 days, and the residence time of liquids in the biological reactor is about 12 to 48 hours.

8. The system of claim 1, wherein the solids separation device comprises a piston-type mechanical press.

9. A thermal treatment system for processing a slurry comprising organic material and water, the system comprising:
a pump that pressurizes the slurry to a pressure above the saturation pressure of water at a subsequent elevated temperature;
at least one thermal input device that heats the slurry to the elevated temperature sufficient for cell lysing and char formation;
a reaction device that provides a retention time at the elevated temperature to thermally treat the heated slurry at the elevated temperature;
a solids separation device that separates the thermally treated slurry into at least a first stream comprising organic materials and a second stream comprising inert materials; and
an anaerobic biological reactor that converts organic materials in the first stream to methane, the biological reactor recycling waste biosolids to the pump, the at least one thermal input device, and the reaction device for further thermal treatment.

10. The system of claim 9, further comprising a thickening device upstream of the pump that increases a solids concentration of the organic material.

11. The system of claim 10, wherein the biological reactor recycles the waste biosolids to the thickening device.

12. The system of claim 9, wherein the second stream from the solids separation device contains particles sized larger than about 20 microns.

13. The system of claim 12, wherein the second stream from the solids separation device contains particles sized larger than about 100 microns.

14. The system of claim 9, wherein the second stream from the solids separation device contains particles having a specific gravity greater than about 0.9.

15. The system of claim 9, wherein the first stream from the solids separation device has a concentration of dissolved organics and light organic particles of about 50 to 10,000 mg/L.

16. The system of claim 10, wherein the solids separation device comprises a hydrocyclone.

17. A method for processing a slurry comprising an organic material and water, the method comprising the steps of:
thermally treating the slurry by heating and pressurizing the slurry;
separating the treated slurry into at least a first liquid stream and a second solid material suitable for disposal as an inert waste;
biologically treating the first liquid stream to produce methane and waste biosolids; and
recycling the waste biosolids from the biological treatment step to the thermal treatment step.

18. The method of claim 17, wherein the second solid material from the separating step comprises dense inert undissolved solids and the first liquid material from the separating step comprises biodegradable dissolved and light undissolved solids.

19. The method of claim 17, wherein the biological treatment step comprises an anaerobic biological treatment process.

20. The method of claim 17, further comprising thickening the slurry before the thermal treatment step to increase a solids concentration of the slurry.

21. The method of claim 19, wherein the recycling step recycles the waste biosolids from the biological treatment step to the thickening step.
